(19) United States
(12) Patent Application Publication
(10) Pub. No.: US 2009/0172987 A1
(43) Pub. Date: Jul. 9, 2009

(54) INDICATION BRAND HAVING RECESSES AT TWO OPPOSITE SIDES

(76) Inventors: Andy Kaoh, Taipei City (TW); Shieh-Hwei Lee Chen, Taipei City (TW)

Correspondence Address: Andy KAOH, 235 Chung - Ho, Box 8-24, Taipei, 235, TW

(21) Appl. No.: 11/969,229

(22) Filed: Jan. 4, 2008

(51) Int. Cl. G09F 7/02

(52) U.S. Cl. 40/611.01

(57) ABSTRACT

An indication brand comprises a frame having at least one embedding grooves at a front side and at least one embedding groove at a backside thereof; the number of the embedding grooves at one side being an even number and the number of the embedding groove at another side being odd number; at least one display panel embedded into the embedding groove of the frame; the display panel being installed with at least one indication symbol; at least one retaining seat installed with a buckling groove; and the retaining seat being embedded into the embedding groove of the frame; and wherein the indication brand is suitable for the display panels with even number or odd number.

### FIELD OF THE INVENTION

The present invention relates to indication brands, and particularly to an indication brand having at least one embedding grooves at a front side and at least one embedding groove at a backside thereof; the number of the embedding grooves at one side being an even number and the number of the embedding groove at another side being odd number so that two sides of the indication brand can be used.

### BACKGROUND OF THE INVENTION

The conventional indication brand has a front surface for display and a fixing surface for retaining the indication brand. The display surface only has a plurality of recesses. The number of the recesses is odd or even. The retaining surface is installed with buckled for fixing to a wall. The back side of the indication brand cannot be used for display. Moreover, when the number of the recesses in the display surface is odd, if it is desired to place display panels of even number, recess can not be used. The same situation is suitable for the case of recesses of even number. Thus two kinds of indication brands are necessary to be prepared for different situations.

The conventional indication brand has the following defects. The number of the display panels is fixed to even number or odd number. Only one side is used for display. Two indication brands are necessary for displaying display panels of even number or odd number. If the number of the recesses for receiving the display panels is not desired, another one must be bought.

### SUMMARY OF THE INVENTION

Accordingly, the primary object of the present invention is to provide an indication brand having at least one embedding grooves at a front side and at least one embedding groove at a backside thereof; the number of the embedding grooves at one side being an even number and the number of the embedding groove at another side being odd number so that two sides of the indication brand can be used.

To achieve above object, the present invention provide an indication brand; comprises a frame having at least one embedding grooves at a front side and at least one embedding groove at a backside thereof; the number of the embedding grooves at one side being an even number and the number of the embedding groove at another side being odd number; at least one display panel embedded into the embedding groove of the frame; the display panel being installed with at least one indication symbol; at least one retaining seat installed with a buckling groove; and the retaining seat being embedded into the embedding groove of the frame; and wherein the indication brand is suitable for the display panels with even number or odd number.

The at least one display panel is formed with at least one embedding recess and at least one protrusions for engaging the at least one protrusion and at least one embedding recess of the display panel.

The indication symbol of the display panel is a number from 0 to 8 or English Characters from A to Z.

The at least one retaining seat is formed with at least one embedding recess and at least one protrusions for combining with the protrusion and embedding groove of the frame.

Each embedding groove is formed with at least one embedding recess and at least one protrusion for engaging the display panel and the retaining seat.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an exploded perspective view of the present invention.

FIG. 3 shows one embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

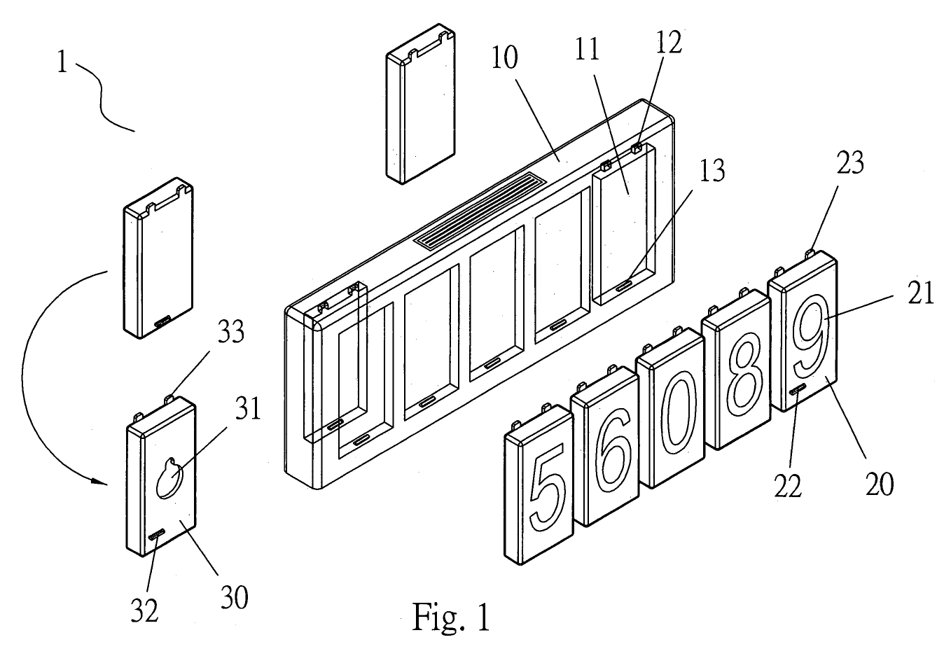

Referring to FIG. 1, the structure of the present invention is illustrated. The indication brand 1 of the present invention has the following elements:

A frame 10 with embedding grooves 11 at a front side and rear side thereof. One side has a single one embedding groove 11 and another side has plurality of embedding grooves 11. The embedding grooves 11 serves for retaining a display panel 20 or retaining seat 30. Each embedding groove 11 is further formed with at least one embedding recess 12 and at least one protrusion 13 for engaging the display panel 20 and the retaining seat 30.

At least one display panel 20 is embedded into the embedding groove 11 of the frame 10. The display panel 20 is installed with at least one indication symbol 21. The at least one display panel 20 is further formed with at least one embedding recess 22 and at least one protrusions 23 for engaging the at least one protrusion 13 and at least one embedding recess 12 of the display panel 20. The indication symbol 21 of the display panel 20 is a number from 0 to 8 or English Characters from A to Z.

At least one retaining seat 30 is installed with a buckling groove 31. The retaining seat 30 is embedded into the embedding groove 11 of the frame 10. The at least one retaining seat 30 is formed with at least one embedding recess 32 and at least one protrusions 33 for combining with the protrusion 13 and embedding groove 11 of the frame 10.

Thereby the user can use one surface or two surface of the indication brand so as to desired effects.

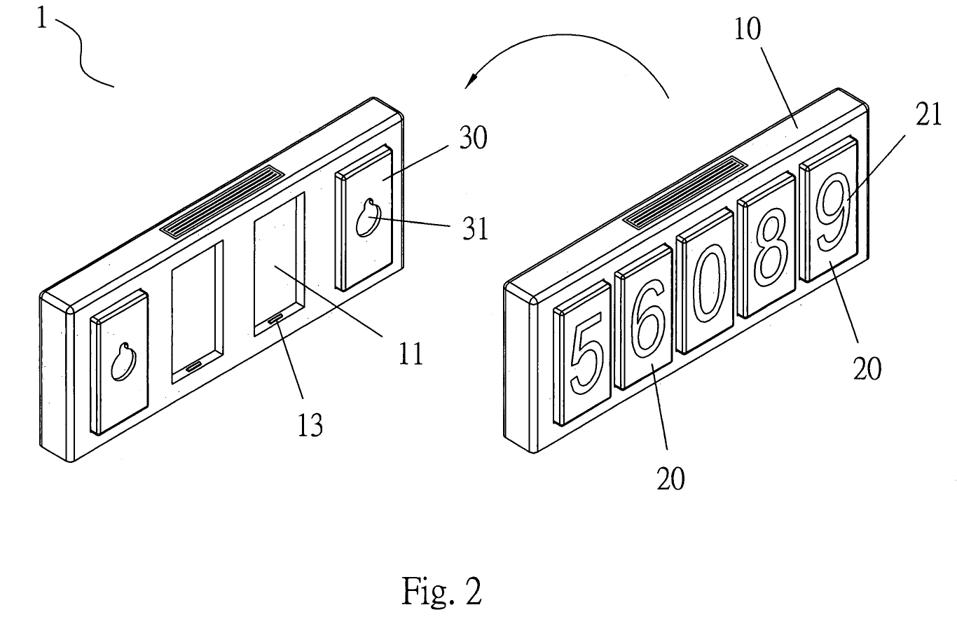

Referring to FIG. 2, the front side and back side of the present invention is illustrated. It is illustrated that the display panel 20 and the retaining seat 30 are fixed to the frame 10. One side of the frame 10 is combined with the display panel 20 and another side thereof is combined with a retaining seat 30.

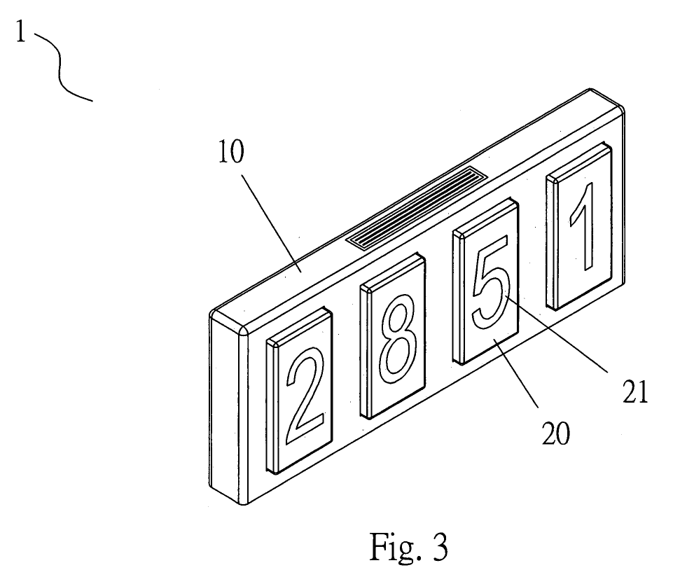

Referring to FIG. 3, the embodiment of the present invention is illustrated. Two sides of the indication brand 1 of the present invention is used for displaying. When the number is an odd number, the embedding groove 11 of odd number is used for displaying. Otherwise, when the number to be displayed is even number. The embedding groove 11 of even number is used for displaying. As illustrated in the drawings, when the embedding groove 11 of even number is used for displaying, after combining with the display panel 20, it can present a beautiful outlook.

Advantage of the present invention will be described herein. The present invention can present even and odd numbers at the same time so as to have a beautiful outlook. At least one retaining seat is used for hanging from the wall. The retaining seat is embedded into the frame. If the number of the numbers on the indication brand is changed from even to odd or from odd to even, it is only necessary to change the side of the indication brand so as to have beautiful outlook. The cost is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An indication brand, ;comprising:
a frame having at least one embedding grooves at a front side and at least one embedding groove at a backside thereof; the number of the embedding grooves at one side being an even number and the number of the embedding groove at another side being odd number;
at least one display panel embedded into the embedding groove of the frame; the display panel being installed with at least one indication symbol;
at least one retaining seat installed with a buckling groove; and the retaining seat being embedded into the embedding groove of the frame.
wherein the indication brand is suitable for the display panels with even number or odd number.

2. The indication brand as claimed in claim 1, wherein the at least one display panel is formed with at least one embedding recess and at least one protrusions for engaging the at least one protrusion and at least one embedding recess of the display panel.

3. The indication brand as claimed in claim 1, wherein the indication symbol of the display panel is a number selected from 0 to 8 and English Characters from A to Z.

4. The indication brand as claimed in claim 1, wherein the at least one retaining seat is formed with at least one embedding recess and at least one protrusions for combining with the protrusion and embedding groove of the frame.

5. The indication brand as claimed in claim 1, wherein each embedding groove is formed with at least one embedding recess and at least one protrusion for engaging the display panel and the retaining seat.
